(19) United States
(12) Patent Application Publication
(10) Pub. No.: US 2025/0238311 A1
(43) Pub. Date: Jul. 24, 2025

(54) CENTRALIZED ENDPOINTS DUMPS COLLECTOR AND ANALYZER

(71) Applicant: SAUDI ARABIAN OIL COMPANY, Dhahran (SA)

(72) Inventors: Junaid Ahmed Jan, Dhahran (SA); Mahmoud Al Jarrash, Al Qatif (SA); Dana Baghabrah, Dammam (SA); Adel Marghalani, Dammam (SA)

(73) Assignee: SAUDI ARABIAN OIL COMPANY, Dhahran (SA)

(21) Appl. No.: 18/420,495

(22) Filed: Jan. 23, 2024

(51) Int. Cl. G06F 11/07; G06F 11/00; G06N 3/0455; G06N 3/084

(52) U.S. Cl. CPC G06F 11/0793; G06F 11/004; G06F 11/0709; G06N 3/0455; G06N 3/084; G06F 2201/805

(57) ABSTRACT

A method for managing a computing system is disclosed. The method includes obtaining, from a number of endpoints in the computing system, data traces related to system crashes occurred in the endpoints, storing the data traces in a central repository, determining a correlation between asset information of the endpoints, characteristics of the data traces, and historical system environment changes in the computing system, generating a machine learning model based at least on the correlation, generating, by at least applying the machine learning model to a current system environment change in the computing system, a prediction of potential failure in at least one of the endpoints, and initiating, in response to the prediction of potential failure, a corrective action to the potential failure.

### BACKGROUND

Enterprise IT environments are under rapid ongoing changes that could cause system failures on thousands of endpoints (e.g., workstations or laptops). Example of those changes are operating system upgrades, security updates installation, and antivirus agent upgrades. Those changes are performed in phases to eliminate or at least reduce their side effects. Nevertheless, the detection of endpoint failures is reactive in the traditional method. The detection relies on waiting for end-users to complain, in which cases their issues are escalated from helpdesk all the way to endpoint administrators. The process of failures diagnosis and resolution is time consuming requiring the administrator to connect to each endpoint for manually collecting and analyzing failure traces. Moreover, the traditional method has limited capacity to address each endpoint individually without forming a comprehensive overview on the magnitude/extent of the problem across all endpoints in the enterprise IT environment.

### SUMMARY

In general, in one aspect, the invention relates to a method for managing a computing system. The method includes obtaining, from a plurality of endpoints in the computing system, a plurality of data traces related to a plurality of system crashes occurred in the plurality of endpoints, storing the plurality of data traces in a central repository, determining a correlation between asset information of the plurality of endpoints, characteristics of the plurality of data traces, and historical system environment changes in the computing system, generating a machine learning model based at least on the correlation, generating, by at least applying the machine learning model to a current system environment change in the computing system, a prediction of potential failure in at least one of the plurality of endpoints, and initiating, in response to the prediction of potential failure, a corrective action to the potential failure.

In general, in one aspect, the invention relates to a data analytic module for managing a computing system. The data analytic module includes a processor, and a memory coupled to the processor and storing instruction. The instructions, when executed by the processor, include functionality for obtaining, from a plurality of endpoints in the computing system, a plurality of data traces related to a plurality of system crashes occurred in the plurality of endpoints, storing the plurality of data traces in a central repository, determining a correlation between asset information of the plurality of endpoints, characteristics of the plurality of data traces, and historical system environment changes in the computing system, generating a machine learning model based at least on the correlation, generating, by at least applying the machine learning model to a current system environment change in the computing system, a prediction of potential failure in at least one of the plurality of endpoints, and initiating, in response to the prediction of potential failure, a corrective action to the potential failure.

In general, in one aspect, the invention relates to a computing system that includes a plurality of endpoints, and a data analytic module having functionality for obtaining, from the plurality of endpoints in the computing system, a plurality of data traces related to a plurality of system crashes occurred in the plurality of endpoints, storing the plurality of data traces in a central repository, determining a correlation between asset information of the plurality of endpoints, characteristics of the plurality of data traces, and historical system environment changes in the computing system, generating a machine learning model based at least on the correlation, generating, by at least applying the machine learning model to a current system environment change in the computing system, a prediction of potential failure in at least one of the plurality of endpoints, and initiating, in response to the prediction of potential failure, a corrective action to the potential failure.

Other aspects and advantages will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a system in accordance with one or more embodiments.

FIG. 2 shows a flowchart in accordance with one or more embodiments.

FIGS. 3A, 3B, and 3C show an example in accordance with one or more embodiments.

FIG. 4 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments of this disclosure provide a system and a method to centrally collect, report and analyze crash dump data of endpoints in a computing environment. The crash dump data are related to Windows operating system events and logs that are stored locally on each endpoint. The centralized collection, reporting and analysis allows administrators to resolve and take necessary actions to remediate computing system failures in a timely manner. In one or more embodiments, a machine learning (ML) model is derived/generated by correlating between the system crashes and recent changes in the computing environment (e.g., OS upgrade, antivirus update, drivers update, security policy change, etc.). Throughout this disclosure, the machine learning model is used to provide an overview of the magnitude/extent of the system crash and proactively alert the system administrators of an on-going problem while minimize the time required to collect, analyze, report and resolve issues and failures.

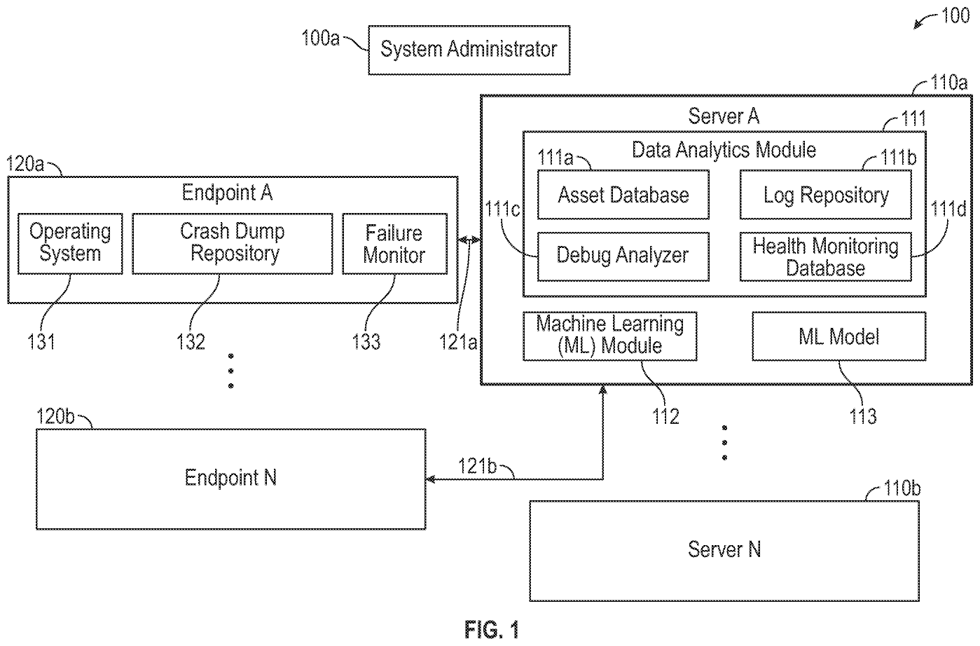

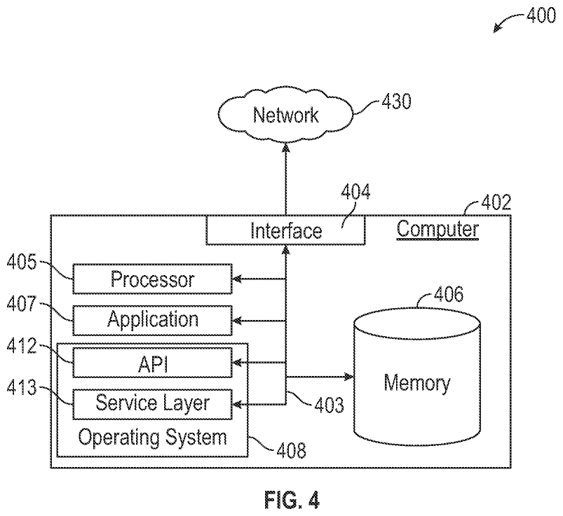

FIG. 1A shows a schematic diagram in accordance with one or more embodiments. As shown in FIG. 1A, the computing system (100) corresponds to an enterprise computing system having a large number of servers and endpoints including hardware, software, and networking systems that a business relies on every day in the course of using information technology (IT). In particular, the hardware may include routers, personal computers, servers, switches, and data centers. The software may include web servers and applications. The networking systems may include firewalls, cables, and other components which facilitate internal and external communication in a business. In one or more embodiments, one or more servers and endpoints are implemented based on the computer system described in reference to FIG. 4 below. In one or more embodiments, one or more of the modules and/or elements shown in FIG. 1 may be omitted, repeated, combined and/or substituted. Accordingly, embodiments disclosed herein should not be considered limited to the specific arrangements of modules and/or elements shown in FIG. 1.

As shown in FIG. 1, the computing system (100) includes one or more servers (e.g., server A (110a), server N (110b)) and endpoints (e.g., endpoint A (120a), endpoint N (120b)) that are coupled via network connections (e.g., network connections (121a, 121b)). The servers and endpoints of the computing system (100) are managed by a system administrator (100a) who is a user that has authority of scheduling and deploying system environment changes (e.g., OS upgrade, antivirus update, drivers update, security policy change, etc.). to support reliable and effective use of the computing system (100). Generally, an endpoint is a computing device that communicates back and forth with a network to which it is connected. Examples of endpoints include desktop computers, laptop computers, smartphones, tablet computers, computer workstations, Internet-of-things (IoT) devices, etc. In one or more embodiments, the servers (e.g., server A (110a)) are also endpoints referred to as server endpoints.

In one or more embodiments, each endpoint in the computing system (100) is configured to automatically detect operating failures by monitoring specific events that are automatically generated by the operation system (OS) of the endpoint. In response to the automatically detected operating failures, the associated dump and log files are collected into a centralized repository and alerts are sent to the system administrator(s) of the computing system (100).

As shown in FIG. 1A, the endpoint A (120a) corresponds to a computer workstation that includes an operating system (131), a crash dump repository (132), and a failure monitor (133). In one or more embodiments, the operating system (131) corresponds to a Windows Operating System developed and marketed by Microsoft, such as Windows 10, Windows NT, Windows Server, Windows IoT, etc. During operations of the endpoint A (120a), a system crash (also known as a “bug check” or a “Stop error”) occurs from time to time when the operating system (131) fails to execute correctly. A dump file is produced from the system crash and may be referred to as a system crash dump. The dump file captures a record of system memory at the time of the system crash.

The operating system event log is a detailed and chronological record of system, security and application notifications stored by the operating system that network administrators use to diagnose system problems and predict future issues. Each event in a log entry may contain, for example, the following information:
Level: Severity of event, including information, critical, warning, error, verbose;
Date: Date an event occurred;
Time: Time an event occurred;
Source: Program or component that caused the event;
Event ID: An identification number that specifies the event type;
Task category: Recorded event log type;
User: Username of the user logged onto the machine when the event occurred;
Computer: Name of the computer.

The operating system and applications use these event logs described above to record important hardware and software actions the administrator can use to troubleshoot issues with the OS. The operating system tracks specific events in its log files, such as application installations, security management, system setup operations on initial startup, and problems or errors.

For example, the Windows Operating System (OS) records events in areas including application events, security events, setup events, system events, and forwarded events. Application events relate to incidents with the software installed on the local computer. If an application crashes, then the Windows event log will create an application log entry about the issue containing the application name and information on why it crashed. Security events store information based on the Windows system's audit policies. Typical events logs stored include login attempts and resource access. For example, the Windows security log stores a record when the computer attempts to verify account credentials when a user tries to log on to a machine. Setup events include enterprise-focused events relating to the control of domains, such as the location of logs after a disk configuration. This log will also keep track of occurrences involving Active Directory on domain controllers. System events relate to incidents on Windows-specific systems, such as the status of device drivers. Forwarded events arrive from other machines on the same network when an administrator wants to use a computer that gathers multiple logs.

In one or more embodiments, the endpoint A (120a) includes the failure monitor (133) and crash dump repository (132) that correspond to hardware and software having the functionality of gathering and storing, respectively, data traces related to system crashes on the endpoint A (120a). Throughout this disclosure, the term “data trace” refers to any collected historical data related to failures of the endpoint. The data traces gathered by the failure monitor (133) and stored in the crash dump repository (132) are not gathered from any single location but from multiple locations as they include Bug Check error code and memory dumps that resulted from having Blue Screen of Death (BSOD), Kernel crash dump that is created whenever the execution of the kernel is disrupted, and Windows System and Applications event logs.

In one or more embodiments, the failure monitor (133) sends selected data traces (e.g., log events) from the crash dump repository (132) as indicators of the system crashes to the server A (110a). In one or more embodiments, the selected log events are generated by the Windows Operating System and include two events identified as event ID 1001 and event ID 41 listed in TABLE 1 below.

```
TABLE 1
  Event ID 1001 [symbol]
ent xmlns=“http://schemas.microsoft.com/win/2004/08/events/event”> [symbol]
ystem> [symbol]
Provider Name=“Microsoft-Windows-WER-SystemErrorReporting” Guid=“{ABCE23E7-
  DE45-4366-8631-84FA6C525952}” EventSourceName=“BugCheck” /> [symbol]
EventID Qualifiers=“16384”>1001</EventID> [symbol]
Version>0</Version> [symbol]
Level>2</Level> [symbol]
Task>0</Task> [symbol]
Opcode>0</Opcode> [symbol]
Keywords>0x80000000000000</Keywords> [symbol]
TimeCreated SystemTime=“2022-09-12T07:36:33.4601891Z” /> [symbol]
EventRecordID>2161377</EventRecordID> [symbol]
Correlation /> [symbol]
Execution ProcessID=“0” ThreadID=“0” /> [symbol]
Channel>System</Channel> [symbol]
Computer>xxxxxxxxxx</Computer> [symbol]
Security />
  </System> [symbol]
ventData> [symbol]
Data Name=“param1”>0x000000d1 (0xffffa302c3097010, 0x0000000000000002,
  0x0000000000000000, 0xfffff80494f11530)</Data> [symbol]
Data Name=“param2”>c:\MEMORY.DMP</Data> [symbol]
Data Name=“param3”>1c1f8456-73f0-4e70-bd9f-c0e66159b3c6</Data>
  </EventData>
  </Event>
  Event ID 41 [symbol]
vent xmlns=“http://schemas.microsoft.com/win/2004/08/events/event”> [symbol]
ystem> [symbol]
Provider Name=“Microsoft-Windows-Kernel-Power” Guid=“{331c3b3a-2005-44c2-
  ac5e-77220c37d6b4}” /> [symbol]
EventID>41</EventID> [symbol]
Version>6</Version> [symbol]
Level>1</Level> [symbol]
Task>63</Task> [symbol]
Opcode>0</Opcode> [symbol]
Keywords>0x8000400000000002</Keywords> [symbol]
TimeCreated SystemTime=“2022-09-12T07:35:55.2853921Z” /> [symbol]
EventRecordID>2161203</EventRecordID> [symbol]
Correlation /> [symbol]
Execution ProcessID=“4” ThreadID=“8” /> [symbol]
Channel>System</Channel> [symbol]
Computer>xxxxxxxxxx</Computer> [symbol]
Security UserID=“S-1-5-18” />
  </System> [symbol]
ventData> [symbol]
Data Name=“BugcheckCode”>209</Data> [symbol]
Data Name=“BugcheckParameter1”>0xffffa302c3097010</Data> [symbol]
Data Name=“BugcheckParameter2”>0x2</Data> [symbol]
Data Name=“BugcheckParameter3”>0x0</Data> [symbol]
Data Name=“BugcheckParameter4”>0xfffff80494f11530</Data> [symbol]
Data Name=“SleepInProgress”>0</Data> [symbol]
Data Name=“PowerButtonTimestamp”>0</Data> [symbol]
Data Name=“BootAppStatus”>0</Data> [symbol]
Data Name=“Checkpoint”>0</Data> [symbol]
Data Name=“ConnectedStandbyInProgress”>false</Data> [symbol]
Data Name=“SystemSleepTransitionsToOn”>0</Data> [symbol]
Data Name=“CsEntryScenarioInstanceId”>0</Data> [symbol]
Data Name=“BugcheckInfoFromEFI”>false</Data> [symbol]
Data Name=“CheckpointStatus”>0</Data>
  </EventData>
  </Event> [symbol]
indicates data missing or illegible when filed
```

In one or more embodiments, the server A (110a) includes a data analytics module (111), a machine learning module (112), and a machine learning (ML) model (113). The data analytics module (111) includes hardware and/or software having the functionality to obtain and analyze data traces sent from endpoints of the computing system (100). In one or more embodiments, the data analytics module (111) includes the asset database (111a), log repository (111b), debug analyzer (111c), and health monitoring database (11d). The asset database (111a) is a database that contains the asset information of each endpoint, such as machine name, user network identifier (id), and IP Address. In one or more embodiments, the asset database (111a) also contains historical information of changes in the system environment (e.g., OS upgrade, antivirus update, drivers update, security policy change, etc.). Some entries of the system environment change may be related to all endpoints as one or more system wide deployment of OS upgrade, antivirus update, drivers update, security policy change, etc. Other entries of the system environment change may be related to certain endpoints as one or more endpoint-specific deployment of OS upgrade, antivirus update, drivers update, security policy change, etc. The log repository (111b) is a data repository containing all data traces (e.g., crash dumps, event logs) collected from the endpoints. The debug analyzer (111c) is a tool that analyses data traces collected from the endpoints. The health monitoring database (111d) is a database containing results from continuous and automated analysis of data traces obtained from all endpoints in the computing system (100).

In one or more embodiments, the machine learning module (112) includes hardware and/or software having the functionality to generate the machine learning model (113) using machine learning algorithms based on a machine learning training data set that include analysis results of the data analytic module (111). Further, the machine learning module (112) generates a real-time failure prediction of each endpoints in the computing system (100) by applying the machine learning model (113) to current changes in the system environment (e.g., OS upgrade, antivirus update, drivers update, security policy change, etc.) of the computing system (100). In one or more embodiments, the debug analyzer (111c) analyze each data trace in the log repository (111b) to determine the type of data traces, such as mini-dump, process dump, automated bluescreen bug check (BSOD) dump, kernel dump, etc. as well as other characteristics (e.g., and relevant system crash timestamps such as time of crash logged by a system timer) of the data traces. Accordingly, the machine learning module (112) correlates between the asset information of the data traces, the type and other characteristics of data traces, and recent changes in the system environment (e.g., OS upgrade, antivirus update, drivers update, security policy change, etc.) of the computing system (100). The recent changes are historical system environment changes that occurred within a pre-determined time period prior to any data trace The correlation and other analysis results are included in the health monitoring database (111d) and used to generate the machine learning model (113).

Machine learning (ML), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning (ML) will be adopted herein, however, one skilled in the art will recognize that the concepts and methods detailed hereafter are not limited by this choice of nomenclature.

Machine learning model types may include, but are not limited to, k-means, k-nearest neighbors, neural networks, logistic regression, random forests, generalized linear models, and Bayesian regression. Also, machine-learning encompasses model types that may further be categorized as “supervised,” “unsupervised,” “semi-supervised,” or “reinforcement” models. One with ordinary skill in the art will appreciate that additional or alternate machine learning model categorizations may be defined without departing form the scope of this disclosure. Machine learning model types are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a model is referred to as selecting the model “architecture.”

A cursory introduction to a few machine learning models and the general principles related to training a supervised machine learning model are provided below. However, while descriptions of machine learning models are provided to aid in understanding, one with ordinary skill in the art will recognize that these descriptions do not impose a limitation on the instant disclosure. This is because one with ordinary skill in the art will appreciate that, due to the depth and breadth of the field, a detailed description of the field of machine learning, and the various model types encompassed by the field, cannot be adequately summarized in the present disclosure.

In machine learning, algorithms are trained to find patterns and correlations in large training data sets and to make the best decisions and predictions based on that analysis. Machine learning algorithms build a model based on sample data, known as training data, in order to make predictions or decisions without being explicitly programmed to do so. A training data set is a dataset of examples used during the learning process to fit the parameters of machine learning algorithms, such as weights of a classifier.

Artificial neural networks (ANNs) are a subset of machine learning in deep learning algorithms. The ANN includes node layers, i.e., an input layer, one or more hidden layers, and an output layer. Each node connects to another node and has an associated weight and threshold. If the output of any individual node is above the specified threshold value, that node is activated, sending data to the next layer of the network. Otherwise, no data is passed along to the next layer of the network. ANNs rely on training data to learn and improve their accuracy over time. A convolutional neural network (CNN) is a class of ANN most commonly applied to analyze visual imagery. CNNs use a mathematical operation called convolution in place of general matrix multiplication in at least one of their layers. CNNs are specifically designed to process pixel data and are used in image recognition and processing.

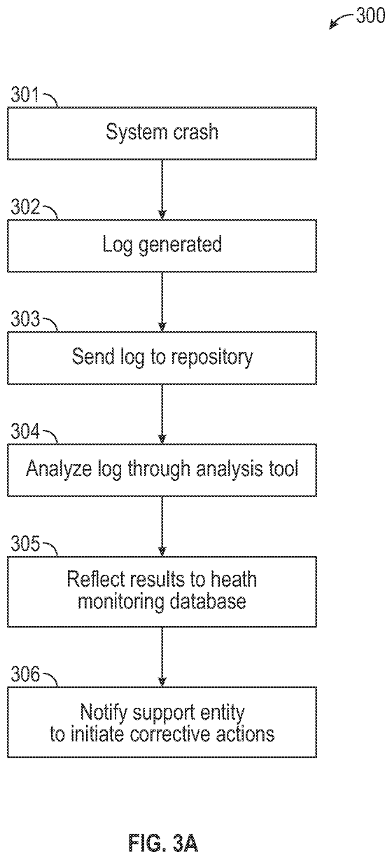

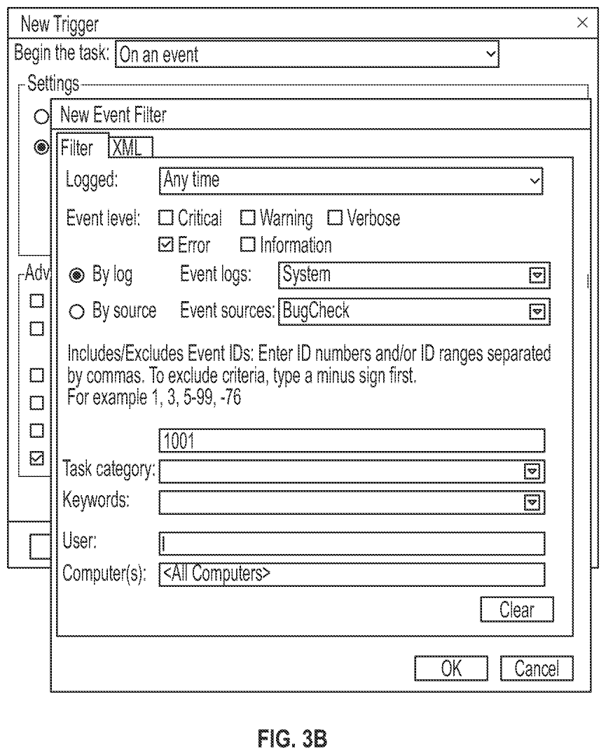

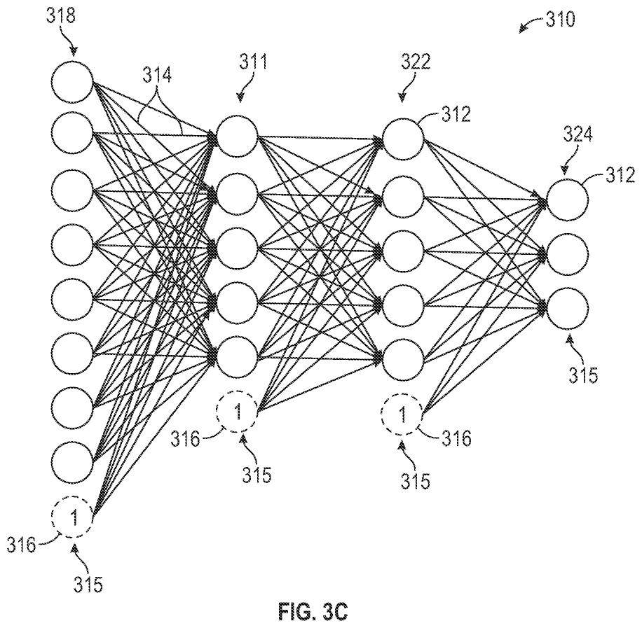

Based on the foregoing, the health monitoring database (111d) are included as part of machine learning training datasets for training the machine learning model (113). In one or more embodiments, the machine learning model (113) includes CNNs. An example of the machine learning model (113) implemented as a CNN is described in reference to FIG. 3C below. In one or more embodiments, each of the data analytics module (111), machine learning module (112), and machine learning model (113) may be implemented in hardware (i.e., circuitry), software, or any combination thereof. Accordingly, the machine learning module (112) generates the real-time failure prediction of each endpoints in the computing system (100) within a short time duration subsequent to each current change in the system environment (e.g., OS upgrade, antivirus update, drivers update, security policy change, etc.) of the computing system (100). With this short time duration made possible by the hardware/software implementation, endpoints administrators would have real-time prediction/detection of system crashes and clear visibility of the root cause in a timely manner not possible by any manual process of failures diagnosis and resolution. As noted above, such manual process is time consuming requiring the administrator to connect to each endpoint for manually collecting and analyzing failure traces. In one or more embodiments, corrective actions or other proactive measures to prevent the predicted endpoint failures are initiated in response to the real-time detection of potential and/or actual system crashes and determination of root causes. Accordingly, system down time is reduced and operation efficiency of the computing system (100) is improved.

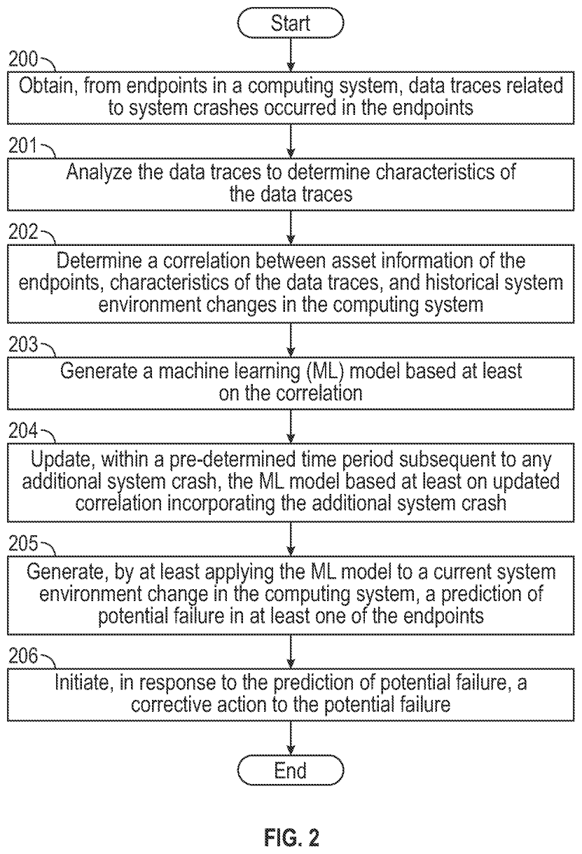

In one or more embodiments, the data analytics module (111), machine learning module (112), and machine learning model (113) collectively perform the functionalities described above by a process described in reference to FIG. 2 below. Although the data analytics module (111) is shown as having four components (111a, 111b, 111c, 111d), in other embodiments disclosed herein, the data analytics module (111) may have more or fewer components. Further, the functionality of each component described above may be split across components. Furthermore, each component (111a, 111b, 111c, 111d) may be utilized multiple times to carry out an iterative operation.

FIG. 2 shows a flowchart in accordance with one or more embodiments. Specifically, One or more blocks in FIG. 2 may be performed using one or more components as described in FIG. 1. While the various blocks in FIG. 2 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Turning to FIG. 2, initially in Block 200, data traces are obtained from endpoints in a computing system. Each of the data traces relates to a system crash that occurred in one of the endpoints. For example, these data traces run after deployments such as software patches, software upgrades, etc. Over the period of these deployments, the data traces are collected if any system crash occurs. The data traces are collected over a period of time and are obtained by a backend server to be stored in a central repository of the backend server. The period of time is selected such that sufficient number of system crashes have occurred to be used as a basis for machine learning. For example, the period of time may be a week, a month, a quarter, etc. In another example, the period of time is determined based on the number of system crashes considered as sufficient, such as one hundred system crashes, one thousand system crashes, etc.

In Block 201, the data traces are analyzed by a data analytic module of the backend server to determine the characteristics of the data traces, such as a type and a timestamp of each of the data traces.

In Block 202, a correlation is determined between asset information of the endpoints, characteristics of the data traces, and historical system environment changes in the computing system. The asset information includes a machine name, a user network identifier (id), and an IP Address of each of the data traces. The historical system environment changes include an operating system (OS) upgrade, an antivirus update, a driver update, and a security policy change that occurred prior to determining the correlation.

In Block 203, a machine learning model is generated based at least on the correlation. In particular, the machine learning model is generated based on a machine learning training dataset containing the asset information of the endpoints, the characteristics of the data traces, and the historical system environment changes in the computing system.

In Block 204, the machine learning model is updated based at least on updated correlation incorporating any additional system crash that may have occurred after the machine learning model is generated. In particular, the machine learning model is updated by hardware/software of the backend server within a pre-determined time period (e.g., tens of millisecond, a second, a minute, etc.) subsequent to any additional system crash. More specifically, an additional data trace separate from the centrally stored data traces is obtained that is related to an additional system crash occurred in the endpoints subsequent to the prior system crashes based on which the machine learning model is trained. The correlation is updated based at least on the characteristics of the additional data trace and an additional system environment change in the computing system subsequent to the historical system environment changes based on which the machine learning model is trained. Accordingly, the machine learning model is updated within the pre-determined time period subsequent to the additional system crash. For example, depending on the computing processing power of the endpoint and the backend server, the machine learning model may be updated within tens of millisecond, a second, a minute, etc. subsequent to any additional system crash.

In Block 205, a current system environment change is identified within the pre-determined time period. In particular, the current system environment change includes one or more of an operating system (OS) upgrade, an antivirus update, a driver update, and a security policy change in the computing system. In response to identifying the current system environment change, a prediction of potential failure in at least one of the endpoints in the computing system is generated by at least applying the machine learning model to the current system environment change.

In Block 206, in response to the prediction of potential failure, a corrective action to the potential failure is initiated. In one or more embodiments, the corrective action includes a proactive action to prevent the potential failure. In particular, the proactive action is initiated within a pre-determined time period (e.g., tens of millisecond, a second, a minute, etc.) after the prediction of potential failure is generated thus providing sufficient time to implement the proactive action prior to a scheduled deployment of the current system environment change. For example, the proactive action may include any necessary preparation of the endpoints to successfully deploy the operating system (OS) upgrade, antivirus update, driver update, and/or security policy change. In contrast, manual monitoring and analysis performed by any human administrator will take too long to predict potential failure thus unable to initiate and complete necessary preparations for successful deployment of system changes. Examples of the proactive action may include upgrading outdated software and/or hardware components.

In one or more embodiments, the corrective action includes a reactive action to mitigate actual occurrence of the potential failure. In particular, the reactive action is initiated within a pre-determined time period (e.g., tens of millisecond, a second, a minute, etc.) subsequent to the actual occurrence of the current system environment change. For example, the reactive action may include any necessary software patch, software and/or hardware updates of the endpoints to successfully complete the operating system (OS) upgrade, antivirus update, driver update, and/or security policy change. For example, depending on the computing processing power of the endpoint and the backend server, the reactive action may be initiated within tens of millisecond, a second, a minute, etc. subsequent to any system crash such that normal system operation may be restored in a timely fashion. In contrast, manual monitoring and analysis performed by any human administrator will take too long before initiating reactive action thus unable to restore normal system operation in a timely fashion.

FIGS. 3A-3C show an example in accordance with one or more embodiments. The example shown in FIGS. 3A-3C is based on the system and method described in reference to FIGS. 1 and 2 above. Specifically, FIGS. 3A-3C illustrate an example functional block diagram to generate real-time failure predictions and initiate corrective actions in an enterprise IT environment. In one or more embodiments, one or more of the modules and/or elements shown in FIGS. 3A-3C may be omitted, repeated, combined and/or substituted. Accordingly, embodiments disclosed herein should not be considered limited to the specific arrangements of modules and/or elements shown in FIGS. 3A-3C.

As shown in FIG. 3A, each endpoint in the enterprise IT environment (300) is configured to collect event logs (302) generated in response to a system crash (301). Whenever any system crash event occurs, a task is triggered in the endpoint to send all generated logs (302) or other relevant data traces to the central log repository (303) in the enterprise IT environment (300). An example is illustrated in the endpoint system configuration menu screenshot depicted in FIG. 3B.

In response to receiving the generated logs (302) and other data traces from the endpoints, an analysis tool (304) in the backend server analyzes the collected traces to generate a comprehensive report about the overall system health of all endpoints and other crash sources. Analysis results (305) are reflected through the health monitoring database. Accordingly, support entity of the enterprise IT environment (300), such as an endpoints administrator, is notified via email or ticket generation to initiate corrective actions (306).

A notable example of a machine learning model that may be used as machine learning model (113) depicted in FIG. 1 above is a neural network (NN), such as a convolutional neural network (CNN) or a recurrent neural network (RNN). A cursory introduction to a NN is provided herein. However, it is noted that many variations of a NN exist. Therefore, one with ordinary skill in the art will recognize that any variation of the NN (or any other machine learning model) may be employed without departing from the scope of this disclosure. Further, it is emphasized that the following discussions of a NN is a basic summary and should not be considered limiting.

A diagram of a neural network is shown in FIG. 3C. At a high level, a neural network (310) may be graphically depicted as being composed of nodes (312), where here any circle represents a node, and edges (314), shown here as directed lines. The nodes (312) may be grouped to form layers (315). FIG. 4 displays four layers (318, 320, 322, 324) of nodes (312) where the nodes (312) are grouped into columns, however, the grouping need not be as shown in FIG. 3C. The edges (314) connect the nodes (312). Edges (314) may connect, or not connect, to any node(s) (312) regardless of which layer (315) the node(s) (312) is in. That is, the nodes (312) may be sparsely and residually connected. A neural network (310) will have at least two layers (315), where the first layer (318) is considered the “input layer” and the last layer (324) is the “output layer.” Any intermediate layer (320, 322) is usually described as a “hidden layer.” A neural network (310) may have zero or more hidden layers (320, 322) and a neural network (310) with at least one hidden layer (320, 322) may be described as a “deep” neural network or as a “deep learning method.” In general, a neural network (310) may have more than one node (312) in the output layer (324). In this case the neural network (310) may be referred to as a “multi-target” or “multi-output” network.

Nodes (312) and edges (314) carry additional associations. Namely, every edge is associated with a numerical value. The edge numerical values, or even the edges (314) themselves, are often referred to as “weights” or “parameters.” While training a neural network (310), numerical values are assigned to each edge (314). Additionally, every node (312) is associated with a numerical variable and an activation function. Activation functions are not limited to any functional class, but traditionally follow the form

$$A = f ( {\sum }_{i ∈ ( i n coming )} [ {( node value )}_{i} {( edge value )}_{i} ] ) , \qquad EQ . 4$$

where i is an index that spans the set of “incoming” nodes (312) and edges (314) and ƒ is a user-defined function. Incoming nodes (312) are those that, when the neural network (310) is viewed or depicted as a directed graph (as in FIG. 3C), have directed arrows that point to the node (312) where the numerical value is being computed. Some functions for ƒ may include the linear function ƒ(x)=x, sigmoid function ƒ(x)=1/1+e^{-x}, and rectified linear unit function ƒ(x)=max(0, x), however, many additional functions are commonly employed. Every node (312) in a neural network (310) may have a different associated activation function. Often, as a shorthand, activation functions are described by the function ƒ by which it is composed. That is, an activation function composed of a linear function ƒ may simply be referred to as a linear activation function without undue ambiguity.

When the neural network (310) receives an input, the input is propagated through the network according to the activation functions and incoming node (312) values and edge (314) values to compute a value for each node (312). That is, the numerical value for each node (312) may change for each received input. Occasionally, nodes (312) are assigned fixed numerical values, such as the value of 1, that are not affected by the input or altered according to edge (314) values and activation functions. Fixed nodes (312) are often referred to as “biases” or “bias nodes” (316), displayed in FIG. 3C with a dashed circle.

In some implementations, the neural network (310) may contain specialized layers (315), such as a normalization layer, or additional connection procedures, like concatenation. One skilled in the art will appreciate that these alterations do not exceed the scope of this disclosure.

As noted, the training procedure for the neural network (310) comprises assigning values to the edges (314). To begin training the edges (314) are assigned initial values. These values may be assigned randomly, assigned according to a prescribed distribution, assigned manually, or by some other assignment mechanism. Once edge (314) values have been initialized, the neural network (310) may act as a function, such that it may receive inputs and produce an output. As such, at least one input is propagated through the neural network (310) to produce an output. Training data is provided to the neural network (310). Generally, training data consists of pairs of inputs and associated targets. The targets represent the “ground truth,” or the otherwise desired output, upon processing the inputs. In the context of the machine learning model (113), an input is a training CDP gather within the training CDP gathers (205), with a location in the training region. An output, or target, is a training velocity trace from the depth velocity model (203) at the same location at the CDP gather. During training, the neural network (310) processes at least one input from the training data and produces at least one output. Each neural network (310) output is compared to its associated input data target. The comparison of the neural network (310) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (310) output and the associated target. The loss function may also be constructed to impose additional constraints on the values assumed by the edges (314), for example, by adding a penalty term, which may be physics-based, or a regularization term. Generally, the goal of a training procedure is to alter the edge (314) values to promote similarity between the neural network (310) output and associated target over the training data. Thus, the loss function is used to guide changes made to the edge (314) values, typically through a process called “backpropagation.”

While a full review of the backpropagation process exceeds the scope of this disclosure, a brief summary is provided. Backpropagation consists of computing the gradient of the loss function over the edge (314) values. The gradient indicates the direction of change in the edge (314) values that results in the greatest change to the loss function. Because the gradient is local to the current edge (314) values, the edge (314) values are typically updated by a “step” in the direction indicated by the gradient. The step size is often referred to as the “learning rate” and need not remain fixed during the training process. Additionally, the step size and direction may be informed by previously seen edge (314) values or previously computed gradients. Such methods for determining the step direction are usually referred to as “momentum” based methods.

Once the edge (314) values have been updated, or altered from their initial values, through a backpropagation step, the neural network (310) will likely produce different outputs. Thus, the procedure of propagating at least one input through the neural network (310), comparing the neural network (310) output with the associated target with a loss function, computing the gradient of the loss function with respect to the edge (314) values, and updating the edge (314) values with a step guided by the gradient, is repeated until a termination criterion is reached. Common termination criteria include reaching a fixed number of edge (314) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (314) values are no longer intended to be altered, the neural network (310) is said to be “trained.”

With respect to a CNN, it is useful to consider a structural grouping, or group, of weights. Such a group is herein referred to as a “filter.” The number of weights in a filter is typically much less than the number of inputs. In a CNN, the filters can be thought as “sliding” over, or convolving with, the inputs to form an intermediate output or intermediate representation of the inputs which still possesses a structural relationship. Like unto the neural network (310), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening.” The flattened representation may be passed to a neural network (310) to produce a final output. Note, that in this context, the neural network (310) is still considered part of the CNN. Like unto a neural network (310), a CNN is trained, after initialization of the filter weights, and the edge (314) values of the internal neural network (310), if present, with the backpropagation process in accordance with a loss function.

Embodiments may be implemented on a computer system. FIG. 4 is a block diagram of a computer system (402) used to provide computational functionalities associated with described algorithms, methods, functions, processes, flows, and procedures as described in the instant disclosure, according to an implementation. The illustrated computer (402) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. In particular, the computer system (402) includes an operating system (408) that is system software to manage computer hardware and software resources, and provide common services for computer programs. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI. The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413) of the operating system (408). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

In some embodiments, the computer (402) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for managing a computing system, comprising:
obtaining, from a plurality of endpoints in the computing system, a plurality of data traces related to a plurality of system crashes occurred in the plurality of endpoints;
storing the plurality of data traces in a central repository;
determining a correlation between asset information of the plurality of endpoints, characteristics of the plurality of data traces, and historical system environment changes in the computing system;
generating a machine learning model based at least on the correlation;
generating, by at least applying the machine learning model to a current system environment change in the computing system, a prediction of potential failure in at least one of the plurality of endpoints; and
initiating, in response to the prediction of potential failure, a corrective action to the potential failure.

2. The method according to claim 1, further comprising:
analyzing the plurality of data traces to determine the characteristics of the plurality of data traces,
wherein the characteristics comprises a type and a timestamp of each of the plurality of data traces,
wherein the asset information comprises a machine name, a user network identifier (id), and an IP Address of each of the plurality of data traces, and
wherein the historical system environment changes comprise an operating system (OS) upgrade, an antivirus update, a driver update, and a security policy change that occurred prior to determining the correlation, and
wherein the machine learning model is generated based on a machine learning training dataset comprising the asset information, the characteristics, and the historical system environment changes.

3. The method according to claim 1,
wherein the corrective action comprises a proactive action to prevent the potential failure, and
wherein the proactive action is initiated prior to a scheduled deployment of the current system environment change.

4. The method according to claim 3, further comprising:
identifying, prior to the scheduled deployment, the current system environment change comprising one or more of an operating system (OS) upgrade, an antivirus update, a driver update, and a security policy change in the computing system.

5. The method according to claim 1,
wherein the corrective action comprises a reactive action to mitigate actual occurrence of the potential failure, and
wherein the reactive action is initiated within a pre-determined time period subsequent to the actual occurrence of the current system environment change.

6. The method according to claim 5, further comprising:
identifying, within the pre-determined time period, the current system environment change comprising one or more of an operating system (OS) upgrade, an antivirus update, a driver update, and a security policy change in the computing system.

7. The method according to claim 1, further comprising:
obtaining, from the plurality of endpoints in the computing system, an additional data trace separate from the plurality of data traces that is related to an additional system crash occurred in the plurality of endpoints subsequent to the plurality of system crashes;
updating the correlation based at least on the characteristics of the additional data trace and an additional system environment change in the computing system subsequent to the historical system environment changes; and
updating, within a pre-determined time period subsequent to the additional system crash, the machine learning model based at least on the updated correlation.

8. A data analytic module for managing a computing system, comprising:
a processor; and
a memory coupled to the processor and storing instruction, the instructions, when executed by the processor, comprising functionality for:
obtaining, from a plurality of endpoints in the computing system, a plurality of data traces related to a plurality of system crashes occurred in the plurality of endpoints;
storing the plurality of data traces in a central repository;
determining a correlation between asset information of the plurality of endpoints, characteristics of the plurality of data traces, and historical system environment changes in the computing system;
generating a machine learning model based at least on the correlation;
generating, by at least applying the machine learning model to a current system environment change in the computing system, a prediction of potential failure in at least one of the plurality of endpoints; and
initiating, in response to the prediction of potential failure, a corrective action to the potential failure.

9. The data analytic module according to claim 8, the instructions, when executed by the processor, further comprising functionality for:
analyzing the plurality of data traces to determine the characteristics of the plurality of data traces,
wherein the characteristics comprises a type and a timestamp of each of the plurality of data traces,
wherein the asset information comprises a machine name, a user network identifier (id), and an IP Address of each of the plurality of data traces, and
wherein the historical system environment changes comprise an operating system (OS) upgrade, an antivirus update, a driver update, and a security policy change that occurred prior to determining the correlation, and
wherein the machine learning model is generated based on a machine learning training dataset comprising the asset information, the characteristics, and the historical system environment changes.

10. The data analytic module according to claim 8,
wherein the corrective action comprises a proactive action to prevent the potential failure, and
wherein the proactive action is initiated period prior to a scheduled deployment of the current system environment change.

11. The data analytic module according to claim 10, the instructions, when executed by the processor, further comprising functionality for:
identifying, prior to the scheduled deployment, the current system environment change comprising one or more of an operating system (OS) upgrade, an antivirus update, a driver update, and a security policy change in the computing system.

12. The data analytic module according to claim 8,
wherein the corrective action comprises a reactive action to mitigate actual occurrence of the potential failure, and
wherein the reactive action is initiated within a pre-determined time period subsequent to the actual occurrence of the current system environment change.

13. The data analytic module according to claim 12, the instructions, when executed by the processor, further comprising functionality for:
identifying, within the pre-determined time period, the current system environment change comprising one or more of an operating system (OS) upgrade, an antivirus update, a driver update, and a security policy change in the computing system.

14. The data analytic module according to claim 8, the instructions, when executed by the processor, further comprising functionality for:
obtaining, from the plurality of endpoints in the computing system, an additional data trace separate from the plurality of data traces that is related to an additional system crash occurred in the plurality of endpoints subsequent to the plurality of system crashes;
updating the correlation based at least on the characteristics of the additional data trace and an additional system environment change in the computing system subsequent to the historical system environment changes; and
updating, within a pre-determined time period subsequent to the additional system crash, the machine learning model based at least on the updated correlation.

15. A computing system, comprising:
a plurality of endpoints; and
a data analytic module comprising functionality for:
obtaining, from the plurality of endpoints in the computing system, a plurality of data traces related to a plurality of system crashes occurred in the plurality of endpoints;
storing the plurality of data traces in a central repository;
determining a correlation between asset information of the plurality of endpoints, characteristics of the plurality of data traces, and historical system environment changes in the computing system;
generating a machine learning model based at least on the correlation;
generating, by at least applying the machine learning model to a current system environment change in the computing system, a prediction of potential failure in at least one of the plurality of endpoints; and
initiating, in response to the prediction of potential failure, a corrective action to the potential failure.

16. The computing system according to claim 15, the data analytic module further comprising functionality for:
analyzing the plurality of data traces to determine the characteristics of the plurality of data traces,
wherein the characteristics comprises a type and a timestamp of each of the plurality of data traces,
wherein the asset information comprises a machine name, a user network identifier (id), and an IP Address of each of the plurality of data traces, and
wherein the historical system environment changes comprise an operating system (OS) upgrade, an antivirus update, a driver update, and a security policy change that occurred prior to determining the correlation, and
wherein the machine learning model is generated based on a machine learning training dataset comprising the asset information, the characteristics, and the historical system environment changes.

17. The computing system according to claim 15,
wherein the corrective action comprises a proactive action to prevent the potential failure, and
wherein the proactive action is initiated prior to a scheduled deployment of the current system environment change.

18. The computing system according to claim 17, the data analytic module further comprising functionality for:
identifying, prior to the scheduled deployment, the current system environment change comprising one or more of an operating system (OS) upgrade, an antivirus update, a driver update, and a security policy change in the computing system.

19. The computing system according to claim 15,
wherein the corrective action comprises a reactive action to mitigate actual occurrence of the potential failure, and
wherein the reactive action is initiated within a pre-determined time period subsequent to the actual occurrence of the current system environment change.

20. The computing system according to claim 19, the data analytic module further comprising functionality for:
identifying, within the pre-determined time period, the current system environment change comprising one or more of an operating system (OS) upgrade, an antivirus update, a driver update, and a security policy change in the computing system.
